(19) United States
(12) Patent Application Publication
(10) Pub. No.: US 2005/0012500 A1
(43) Pub. Date: Jan. 20, 2005

(54) Path sensor with an magnetoelectric transformer element

(76) Inventors: Alexander Braun, Pforzheim (DE); Wolfgang Welsch, Heidelberg (DE)

Correspondence Address: Striker Striker & Stenby, 103 East Neck Road, Huntingtion, NY, 11743, US

(21) Appl. No.: 10/496,280

(22) PCT Filed: Jan. 17, 2003
(86) PCT No.: PCT/DE03/00117

(30) Foreign Application Priority Data
Jan. 23, 2002 (DE) 102 02 318.2
Dec. 13, 2002 (DE) 102 58 254.8

(51) Int. Cl. G01B 7/14

(52) U.S. Cl. 324/207.24; 324/207.11; 324/207.22

(57) ABSTRACT

The invention relates to a displacement sensor (1a; 1b; 1c) with at least one magnetoelectric transducer element (5) and a magnetic circuit composed of at least one flux conductor (3, 4; 9, 10; 14, 15) and at least one magnet (2; 11), which is small in size and with which the influence on the magnetic flux caused by the movement of an element is capable of being measured with the transducer element (5). During the displacement measurement, the flux conductors (3, 4; 9, 10; 14, 15) and the transducer element (5) are situated in an unchanged position in relation to each other, whereby these parts (3, 4, 5; 9, 10; 14, 15) and the at least one magnet (2; 11) are capable of being moved relative to each other. A change in the magnetic field that is capable of being evaluated by the transducer element (5) is induced by a change in the air gap (d) in the magnetic circuit while the magnet (2; 11) moves. The flux conductors (3, 4; 9, 10; 14, 15) of the magnetic circuit have a contour surrounding the path of the magnet (2; 11) such that the change in width (d) of the air gap along the path course (6; 12) results in a predetermined signal behavior in the transducer element (5).

### BACKGROUND INFORMATION

The present invention relates to a displacement sensor with at least one magnetoelectric transducer element for detecting the movement of a component according to the definition of the species of the main claim.

A sensor arrangement for an angle sensor is already known from DE 43 17 259 A1, in the case of which a magnetic flux generator for producing a measurable magnetic flux is located in an electric control device. Magnetoelectric transducers are provided here, with which a change in the magnetic flux, caused by the rotational movement of a magnetically conductive body, are capable of being detected. With the known magnetoelectric transducer elements, a measurement effect is utilized that occurs when the magnetic flux density in the transducer element is changed as a function of the angle or displacement. This usually occurs when magnetically conductive flux conductors and the permanent magnet are rotated relative to each other in the magnetic circuit composed of flux conductors and permanent magnet, thereby resulting in a change in the flux density at the transducer element. These principles result in undesired side-effects, e.g., caused by the axial play of the moved parts, which also change the fields in the transducer element—due to a change in the air gap width—and, therefore, the measured result. Furthermore, the overall lengths of the displacement sensors are often substantially greater than the displacement to be measured, which makes installation difficult in many applications. Publication DE 197 53 775 A1 makes known that, with a measurement device of this nature having a Hall element as the displacement sensor, flux conductors composed of magnetically conductive material are used to direct the magnetic lines of flux. Furthermore, EP 0 670 471 A1 describes an arrangement with which none of the parts that form the magnetic circuit move relative to each other. In this case, the entire magnetic circuit is therefore rotated past the magnetoelectric transducer. The measurement effect is achieved by the shaping of the magnets, which have a defined change in air gap throughout the angle of rotation.

### ADVANTAGES OF THE INVENTION

In a further development of a displacement sensor for detecting a movement according to the general class, having a magnetoelectric transducer element and a magnetic circuit, it is advantageously achieved, according to the invention, that the flux conductors and the transducer element, preferably a Hall element, are situated in an unchanged position relative to each other during the displacement measurement, whereby these parts and the at least one magnet are capable of being moved relative to each other. A change in the magnetic field that is capable of being evaluated by the transducer element is advantageously induced by a change in the air gap in the magnetic circuit while the magnet moves. A particular advantage of the invention in this case is the small overall length of the displacement sensor, which can also be installed in structurally critical sites on an assembly or with other applications. The displacement sensor according to the invention is insensitive to displacements of the moved magnet transversely to the direction of motion, because an increase in size on one side of the air gap is compensated by a reduction in size on the other side of the air gap. An insensitivity in the other direction transverse to the extension of the flux conductors can be achieved in simple fashion by sizing the component height accordingly, whereby the flux conductors are then always taller than the magnet. The flux conductors of the magnetic circuit advantageously have a contour surrounding the path of the magnet such that the change in width of the air gap along the course of the path results in a predetermined signal behavior in the transducer element. The magnetic field, which is therefore variable, is largely defined here by the width of the air gap as working gap and allows, in simple fashion, a variable slope of the characteristic curve, even including angles or displacement measuring ranges without signal changes, namely a “plateau”, or including bent characteristic lines. The contour of the flux conductors is preferably shaped such that a linear measurement curve results over the course of the path. With an advantageous embodiment, the displacement sensor is a linear displacement sensor, and the path course of the relative motion of the magnetic circuit and the transducer element is a straight line. In this case, the size is only slightly larger than the measurement path. According to another, advantageous embodiment, the sensor is an angle sensor, and the path course of the relative motion of the magnetic circuit and the transducer element is a circle or a segment of a circle. It is also advantageous when the flux conductors each include a projection, as pole shoe, guiding toward transducer element in the region of the transducer to induce a flux concentration. As a result of the therefore enlarged air gap width, it is possible to use larger magnets with lower leakage flux and, therefore, to work with more magnetic flux; this simplifies the electrical signal processing. One possible application, among others, of the displacement sensor according to the invention is as a “pedal-travel sensor” for electrohydraulic brakes in motor vehicles.

### DRAWING

Exemplary embodiments of the invention are explained with reference to the drawing.

FIG. 1 shows a displacement sensor for a linear displacement measurement with a suitable contour of flux conductors for linear signal behavior.

FIG. 2 shows a displacement sensor for a linear displacement measurement having one pole shoe each on the flux conductors, the pole shoes being diametrically opposed to the transducer element.

FIG. 3 shows a displacement sensor for a radial displacement measurement having a suitable contour of flux conductors for a linear signal behavior.

FIG. 4 shows a displacement sensor, with which the flux conductors have a constant thickness, and

FIG. 5 shows an exemplary embodiment with specially-shaped pole shoes.

### DETAILED DESCRIPTION OF THE EMBODIMENTS

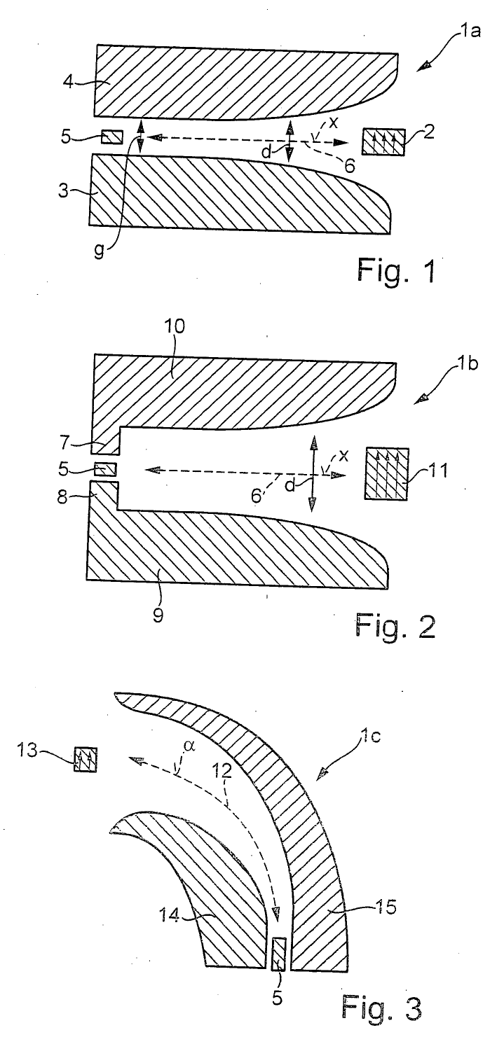

A linear displacement sensor 1a is depicted in FIG. 1, which includes a magnetic circuit composed of a permanent magnet 2 and two flux conductors 3 and 4, e.g., composed of iron, and a Hall element 5, as electromagnetic transducer, fixed in position between the ends of flux conductors 3 and 4 in measurement air gap g. Magnet 2 is movable along a path course 6 of measurement path x, whereby, due to a suitable configuration of the contour of flux conductors 3 and 4, an air gap having a changeable gap width d can be produced along the course of displacement measurement path x. Due to the change in width d along path course 6, a signal behavior that is predetermined by the contour of flux conductors 3 and 4 is capable of being sensed in Hall element 5. An exemplary embodiment of a linear displacement sensor 1b is shown in FIG. 2, with which a greater width d of air gap in the course of the path along displacement measurement path x can be produced by pole shoes 7 and 8. Pole shoes are formed by projections on the ends of flux conductors 9 and 10, diametrically opposed to Hall element 5, and act here as flux concentrators. With this exemplary embodiment, a longer (i.e., in the direction of the air gap) magnet 11 can therefore be used, so that a greater flux density may therefore be produced with less leakage flux. With the exemplary embodiment according to FIG. 3, path course 12 of the relative motion along measurement path α describes a circular path in sections, so that a radial path or angle sensor 1c results. The magnetic circuit is equipped with a magnet 13 and corresponding flux conductors 14 and 15, the shape of which is configured according to the principles explained with reference to FIG. 1, however. The measurement signal is also detectable with a Hall element 5 situated in a fixed manner between the ends of flux conductors 14 and 15.

When magnet 2, 5, 11, 30 moves along path x, the magnetic flux in measurement air gap g therefore changes due to the change in working air gap d and the material thickness of the flux conductors.

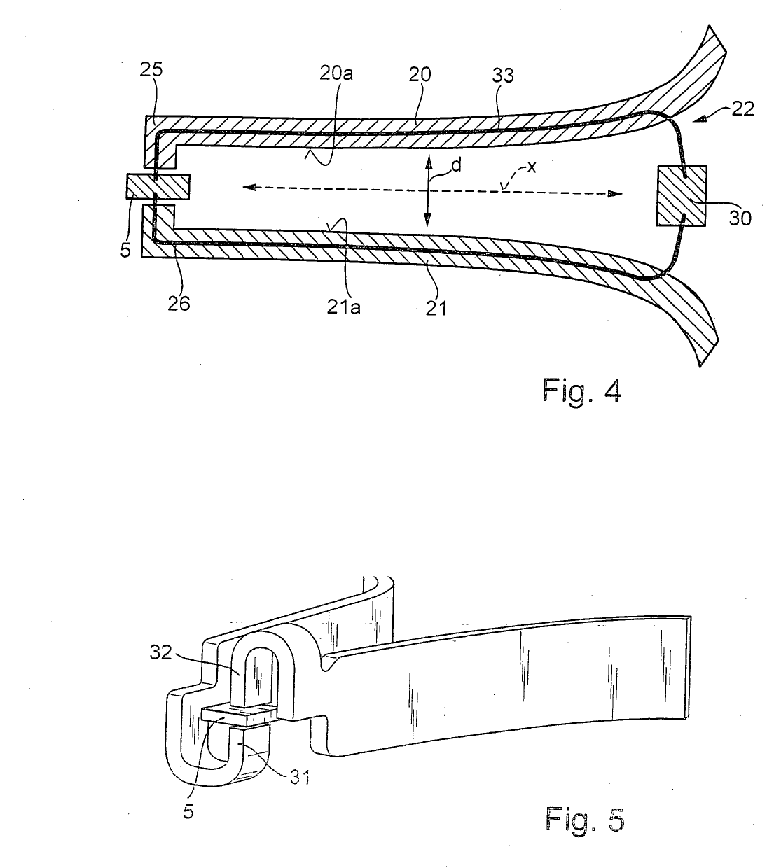

In the exemplary embodiment according to FIG. 4, the flux change in measurement air gap g that occurs when the magnet moves along x is achieved soley by the continuous curvature of the flux conductors having contast thickness. In the exemplary embodiment according to FIG. 4, flux conductors 20, 21 have the same thickness along the entire length. This also applies in the “region of the opening” 22 of the displacement sensor. In the previous exemplary embodiments, in particular according to FIGS. 1 and 2, the outer walls of flux conductors 3, 4 and/or 9, 10 extend in parallel throughout the entire length. By reducing the thickness of said flux conductors, a continuously changing distance d in direction x was achieved there in the interior, in particular in the region of the opening. In the embodiment according to FIG. 4, flux conductors 20, 21 are now bent away from each other, i.e., their inner sides 20a and 21a that face toward each other have a curved shape, so that a maximum distance d between flux conductors 20, 21 results in the “region of the opening” 22. The variable configuration of the characteristic curve that was described is possible due to an adapted curvature of the flux conductors. Different slopes, plateaus, abrupt transitions for switching procedures can be achieved in simple fashion. For example, a linear characteristic curve is obtained by compensating for the non-linear dependence of the magnetic flux density on gap width d via the curvature of the flux conductors. Pole shoes can still be used to concentrate flux in measurement air gap g and to use larger magnets. It would also be feasible to allow the curved, continuously extending shape in front of pole shoes 25, 26, as shown in FIG. 4, to transition into a parallel region. Said parallel region should then have at least the length of magnet 30, in order to hereby signal an end position. Hall element 5 is situated between the two pole shoes 25, 26. An embodiment without pole shoes is also feasible, as shown in FIG. 1. Pole shoes 25, 26 have the task of concentrating the magnetic flux toward the Hall element. Pole shoes 25, 26 can have the same thickness as flux conductors 20, 21. In FIG. 4, reference numeral 33 depicts the course of the magnetix flux of magnet 30. The polarity of the magnet corresponds to that in the previous depiction. If magnet 30 is moved in direction x, the distance d between flux conductors 20, 21 changes. This change in distance causes the magnetic field in the Hall element to change, the change being proportional to displacement x. The depiction according to FIG. 4 has the advantages, in particular, that flux conductors of this nature are capable of being fabricated using simple manufacturing processes, e.g., punching and bending. Flux conductors having greater height can be manufactured as a result, without using machining processes. This results in a material-saving design. A further advantage is provided by the configuration of measurement air gap g, namely that shapes are configurable there that allow Hall elements to be used in highly diverse housing forms, in particular those that are common in large-series production for printed circuit boards. An example of this is shown in FIG. 5. In this case, the ends of flux conductors 20, 21 are partially stamped, and the remaining areas 31, 32 are bent in a horseshoe shape. Measurement air gap g and Hall element 5 are located between the end faces of areas 31, 32. The ends of the flux conductors can have any shape, so that the magnetic flux density can be oriented in any direction toward measurement path x. This results in a concentration of the magnetic flux density in measurement air gap g and in greater freedom in terms of integrating the sensor in other modules, e.g., in the actuation unit of the electrohydraulic brake.

1. A displacement sensor with at least one magnetoelectric transducer element (5) and a magnetic circuit composed of at least one flux conductor (3, 4; 9, 10; 14, 15, 20, 21) and at least one magnet (2; 11, 30), with which an influence on the magnetic flux—that is capable of being measured with the transducer element (5)—caused by the movement of an element is induced, wherein the flux conductors (3, 4; 9, 10; 14, 15, 20, 21) and the transducer element (5) are situated in an unchanged position relative to each other during the displacement measurement, whereby these flux conductors (3, 4, 5; 9, 10; 14, 15, 20, 21) and the at least one magnet (2; 11, 30) are capable of being moved relative to each other, and a change in the magnetic field that is capable of being evaluated by the transducer element (5) is inducible by a change in the air gap (d) in the magnetic circuit while the magnet (2; 11 30) moves.

2. The displacement sensor as recited in claim 1,
wherein the flux conductors (3, 4; 9, 10; 14, 15, 20, 21) of the magnetic circuit have a contour surrounding the path of the (2; 11, 30) such that the change in width (d) of the air gap along the path course (6; 12) results in a predetermined signal behavior in the transducer element (5).

3. The displacement sensor as recited in claim 2,
wherein the contour of the flux conductors (3, 4; 9, 10, 20, 21) is shaped such that a linear measurement curve results over the path course (6).

4. The displacement sensor as recited in claim 1,
wherein the flux conductors (20, 21) have a nearly constant wall thickness, and the flux conductors (20, 21) have a curved shape in the region of the opening (22), at the least.

5. The displacement sensor as recited in claim 1,
wherein the inner sides (20a, 21a) of flux conductors (20, 21) have a continuously extending, bent shape.

6. The displacement sensor as recited in claim 1,
wherein the inner sides (20a, 21a) of flux conductors (20, 21) include at least one section extending parallel to each other.

7. The displacement sensor as recited in claim 1, wherein the displacement sensor is a linear displacement sensor (1a; 1b) and the path course (6) of the relative motion of the parts (3, 4, 5; 9, 10, 20, 21) and the magnet (2; 11, 30) is a straight line.

8. The displacement sensor as recited in claim 1, wherein the displacement sensor is a tilt sensor (1c), and the path course (12) of the relative motion of the parts (5, 14, 15) and the magnet (2) is a circle or a segment of a circle.

9. The displacement sensor as recited in claim 1, wherein the flux conductors (3, 4; 9, 10, 20, 21) each include, in the region of the transducer element (5), a projection (7, 8) guiding toward the transducer element (5), as flux concentrator.

10. The displacement sensor as recited in claim 1, wherein the transducer element is a Hall element (5).
